(19) United States
(12) Patent Application Publication
(10) Pub. No.: US 2003/0005316 A1
(43) Pub. Date: Jan. 2, 2003

(54) Radio location based theft recovery mechanism

(75) Inventor: Luke E. Girard, Santa Clara, CA (US)

Correspondence Address: ANTONELLI TERRY STOUT AND KRAUS, SUITE 1800, 1300 NORTH SEVENTEENTH STREET, ARLINGTON, VA, 22209

(73) Assignee: INTEL CORPORATION

(21) Appl. No.: 09/892,667

(22) Filed: Jun. 28, 2001

(51) Int. Cl. H04L 9/32

(52) U.S. Cl. 713/193

(57) ABSTRACT

A mobile system is provided with a theft recovery mechanism. The mobile system comprises a host chipset; a locator subsystem connected to the host chipset and arranged to determine a current location of the mobile system; and a main storage connected to the host chipset and arranged to store an operating system (OS) and contain an OS-Present application and/or a Pre-OS application configured to enforce security policies during user authentication, to access the locator subsystem and determine whether the mobile system may have been stolen or used inappropriately based on the security policies.

### TECHNICAL FIELD

The present invention relates to a security system, and more particularly, relates to a radio location based theft recovery mechanism for an electronic device such as a mobile PC equipped with a radio-frequency (RF) locator subsystem for providing security services of varying complexity, including enforcing security policies and obtaining location based information in order to report the location of a stolen device to a proper authority, for example, the police to track and recover the stolen device.

### BACKGROUND

Electronics devices such as notebook and laptop computers, cellular telephones, personal digital assistants (PDAs), and other computing devices have become increasingly compact and portable and, hence, increasingly vulnerable to unauthorized use, theft or loss. This is because these portable devices are small, expensive and may contain very valuable information.

Many computers, especially portable computers (or mobile “PCs”), have been secured from unauthorized use, theft or loss by mechanisms based on principles of prevention, deterrence or recovery. Prevention mechanisms may include physical locking devices or cables which lock portable computers to docking stations. Deterrence mechanisms may include myriad alarm systems which employ various deterrence methods, including sound and visual alarms to deter an unauthorized person or a thief from stealing the portable computers. Recovery mechanisms may include various systems for locating and tracking stolen portable computers for recovery via existing radio communication infrastructures or existing cellular network infrastructures.

One typical example of computer tracking systems for locating stolen computers is the use of a software (location tracking program) installed to instruct the computer to call a third party monitoring service at regular intervals. When the computer calls the monitoring service, the computer establishes a data link and transmits data to the monitoring service that identifies the computer. When the monitoring service receives a call from the user's computer, the monitoring service is able to determine the location of the computer by utilizing Caller ID. The location of the computer may then be forwarded to a law enforcement agency so that the lost or stolen computer can be retrieved by the law enforcement agency.

Alternatively, the location tracking program may also be installed to identify if an e-mail is being sent from the lost or stolen computer and compare a sender address to a predetermined owner address. If the sender address matches the owner address, the e-mail is sent unimpeded. However, if the sender address does not match with the sender address, then the e-mail is redirected to a third party such as a law enforcement agency to notify that the computer may have been stolen. However, such location tracking systems are typically complex, and are not optimal because a third party monitoring service is required.

Another example location tracking systems are known as Radio Frequency Identification (RFID) systems which are available to uniquely identify and track devices equipped with RFID tags as disclosed, for example, in U.S. Pat. No. 6,232,870 for Applications For Radio Frequency Identification Systems issued to Garber et al., U.S. Pat. No. 6,100,804 for Radio Frequency Identification System issued to Brady et al., U.S. Pat. No. 5,963,134 for Inventory System Using Articles With RFID Tags issued to Bowers et al., and U.S. Pat. No. 5,838,253 for Radio Frequency Identification Label issued to Wurz et al. A typical RFID tag (also known as transponder) consists of a semiconductor chip having RF circuits, control logic, memory and an antenna (and a battery in the case of active tags) mounted to a substrate for providing remote identification. However, such RFID systems require dedicated wireless communications, and contain no general wireless data communications capabilities. Another drawback is that the user has purchase the RFID tags, the tag reader, and setup the environment specifically for the RFID service. RFID tags can also be cost prohibitive as each RFID tag can vary from 50 cents to $150 based on the desired capabilities.

Accordingly, there is a need for a new type of asset security architecture and a radio-frequency (RF) location based theft recovery mechanism for an electronic device such as a mobile PC for providing security services of varying complexity, including enforcing security policies and obtaining location based information in order to report the location of a stolen device to a proper authority for tracking and recovering the stolen device. There is also a need for a pre-operating system (Pre-OS) solution or an operating system present (OS-Present) solution based on trigger security policies for communicating with a platform-based RF-based locator subsystem to obtain and transmit location based information to report the location of a stolen device.

### BRIEF DESCRIPTION OF THE DRAWINGS

A more complete appreciation of exemplary embodiments of the present invention, and many of the attendant advantages of the present invention, will become readily apparent as the same becomes better understood by reference to the following detailed description when considered in conjunction with the accompanying drawings in which like reference symbols indicate the same or similar components, wherein:

FIG. 1 illustrates an example system platform of an electronic device such as a mobile PC according an embodiment of the present invention;

FIG. 2 illustrates a system architecture of pre-operating system (Pre-OS) applications and operating system-present (OS-Present) applications according to an embodiment of the present invention;

FIG. 3 illustrates an example Pre-OS (BIOS) application flow of a mobile PC for enforcing security policies according to an embodiment of the present invention;

FIG. 4 illustrates an example OS-Present (operating system) application flow of a mobile PC for enforcing security policies according to an embodiment of the present invention;

FIG. 5 illustrates an example RF-based locator subsystem according to an embodiment of the present invention;

FIG. 6 illustrates an example RF-based locator subsystem according to another embodiment of the present invention; and

FIG. 7 illustrates an example RF-based locator subsystem according to yet another embodiment of the present invention.

### DETAILED DESCRIPTION

The present invention is applicable for use with all types of electronic devices, such as, for example, cellular telephones, personal digital assistants (PDAs), and mobile PCs including a radio-frequency (RF) location based mechanism incorporated therein to determine its current location using, for example, Global Positioning Satellite (GPS), RF-triangulation methods and the like and, in some instances, report the current location via the Internet and the like (using modems), or via radio-frequency (RF) based wireless networks. Examples of such RF-based networks may include, but not limited to, Global Positioning Satellite (GPS) systems and other satellite or land-based networks such as cellular communication radio systems, Bluetooth™ based radio systems, IEEE 802.11b standard based radio systems designed for connecting a variety of electronic devices such as mobile PCs in a secure fashion.

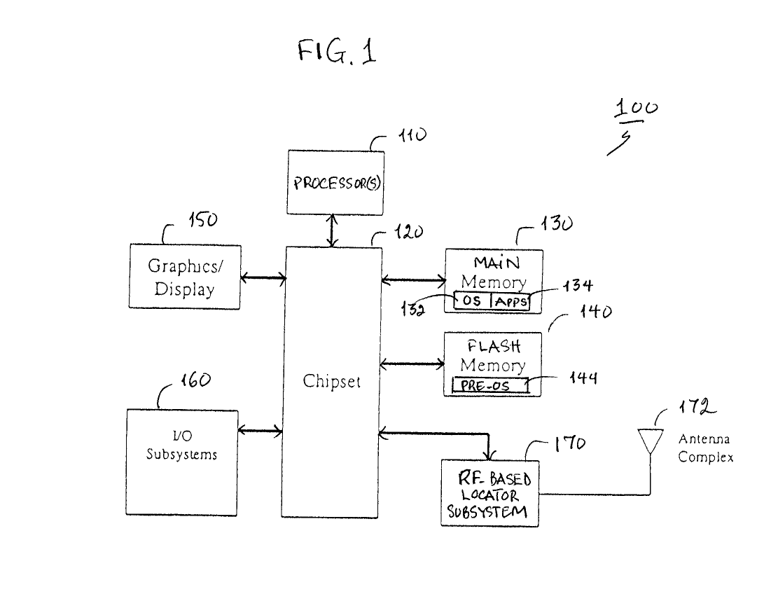

Attention now is directed to the drawings and particularly to FIG. 1, an example system platform of an electronic system such as a mobile PC 100 according an embodiment of the present invention. The system platform advantageously supports pre-operating system (Pre-OS) applications or operating system present (OS-Present) applications that utilize various security codes and enforce trigger security policies for providing security services of varying complexity, including accessing a RF-based locator subsystem to determine the current location of the mobile PC 100 in order to report the current location of the mobile PC 100 (if lost or stolen) to a proper authority, via the Internet or a RF-based wireless network, for tracking and recovering the stolen device.

As shown in FIG. 1, the mobile PC 100 may include, but not limited to, a processor subsystem 110, a host chipset 120, a main storage 130 and a protected storage 140 connected to the host chipset 120, a graphics/display subsystem 150 connected to the host chipset 120, the I/O subsystem 160 connected to the host chipset 120, and a RF-based locator subsystem 170 including an antenna complex 172 arranged to obtain radio location based information relating to the location of the mobile PC 100.

The processor subsystem 110 may also include one or more processors or central processing units (CPUs) such as Intel® i386, i486, Celeron™ or Pentium® processors.

The main memory 130 may correspond to a dynamic random-access-memory (DRAM), but may be substituted for read-only-memory (ROM), video random-access-memory (VRAM) and the like. Such a memory 130 may contain an operating system (OS) 132 such as Windows™ 95/98 and Windows™ 2000 for use by the processor subsystem 110, and one or more OS-Present application programs 134. OS-Present application programs 134 may be any application program that may execute while the operating system (OS) is present.

The flash memory 140 may contain Pre-OS application programs 144 such as, for example, a set of system basic input/output start-up instructions (system BIOS) as well as other applications that may execute during boot up (start-up) before the operating system (OS) 132 is loaded, and other power saving instructions for full-on, standby and sleep states in accordance with the Advanced Power Management (APM) specification jointly developed by Intel Corp. and Microsoft Corp. in February 1996, and the Advanced Configuration and Power Interface (ACPI) specification, version 1.0B, jointly developed by Intel Corp., Microsoft Corp. and Toshiba Corp. in February 1999. The Pre-OS application programs such as the system BIOS 144 may require user authentication such as a password before allowing the operating system (OS) to boot. Typically, a password or other authentication must be provided to allow for completion of booting of an operating system (OS), connecting to a network, accessing a database, or starting application programs such as, for example, an electronic mail program. Alternatively, the Pre-OS application programs 144 may also be stored in the main memory 130 along with the operating system (OS) 132 and the OS-Present application programs 134.

The graphics/display subsystem 150 may include, for example, a graphics controller, a local memory and a display monitor (e.g., cathode ray tube, liquid crystal display, flat panel display, etc.).

The IO subsystem 160 may provide an interface with a variety of I/O devices and the like, such as: a Peripheral Component Interconnect (PCI) bus (PCI Local Bus Specification Revision 2.2 as set forth by the PCI Special Interest Group (SIG) on Dec. 18, 1998) which may have one or more I/O devices connected to PCI slots, an Industry Standard Architecture (ISA) or Extended Industry Standard Architecture (EISA) bus option, and a local area network (LAN) option for communication peripherals such as telephone/fax/modem adapters, answering machines, scanners, personal digital assistants (PDAs) etc; a super I/O chip (not shown) for providing an interface with another group of I/O devices such as a mouse, keyboard and other peripheral devices; an audio coder/decoder (Codec) and modem Codec; a plurality of Universal Serial Bus (USB) ports (USB Specification, Revision 2.0 as set forth by the USB Special Interest Group (SIG) on Apr. 27, 2000); and a plurality of Ultra/66 AT Attachment (ATA) 2 ports (X3T9.2 948D specification; commonly also known as Integrated Drive Electronics (IDE) ports) for receiving one or more magnetic hard disk drives or other I/O devices.

The USB ports and IDE ports may be used to provide an interface to a hard disk drive (HDD), a compact disk read-only-memory (CD-ROM), a readable and writeable compact disk (CDRW), a digital audio tape (DAT) reader. I/O devices may include, for example, a keyboard controller for controlling operations of an alphanumeric keyboard, a cursor control device such as a mouse, track ball, touch pad, joystick, etc., a mass storage device such as magnetic tapes, hard disk drives (HDD), floppy disk drives (FDD), memory sticks and serial and parallel ports to printers, scanners, and display devices.

The host chipset 120 may correspond to, for example, in Intel® 810, Intel® 870 and 8XX series chipsets which include, for example, a memory controller hub (MCH) for controlling operations of the main storage 130 and an IO controller hub (ICH) for controlling operations of the protected storage 140 and a variety of I/O devices, via standard PCI, ISA or EISA bus.

The RF-based locator subsystem 170 may contain an identification (ID) number unique to the mobile PC 100 for identification purposes and can determine information relating to the location of the mobile PC 100 using, for example, Global Positioning Satellite (GPS), and RF-triangulation methods.

The RF-based locator subsystem 170 may be integrated into the host chipset 120 as system-on-chip designs that is compatible with ASIC (Application-Specific Integrated Circuit) design flows. Alternatively, the RF-based locator subsystem 170 may be a single “plug-andplay” module, including the ASIC and passive components for communications over longer distances.

According to an embodiment of the present invention, a Pre-OS application program such as the system BIOS 144 may be configured in accordance with Intel® Protected Access Architecture (IPAA) described in Application Interface Specification, Revision 1.0 available from Intel Corporation of Santa Clara, Calif. (the “IPAA Specification”). More specifically, the Pre-OS application program (system BIOS) 144 may be configured with security code (IPAA control code) that can be activated to trigger and enforce security policies during the boot process from the time the power is turned on (or during certain resume sequences) until control is passed to the operating system (OS) 132.

Similarly, an OS-Present application program 134 may be configured with security code that can be incorporated or integrated into the operating system (OS) 132 and can be activated to load, monitor and enforce (trigger) security policies for user authentication, while the operating system (OS) is loaded.

Security code (IPAA control code) of the OS-Present application program 134 and/or the Pre-OS application program (system BIOS) 144 may routinely access the RF-based locator subsystem 170 to determine the current location of the mobile PC 100 during boot-up and/or during normal operation. The security code (IPAA control code) may check whether any of the security policies has been violated to make a decision that is the mobile PC 100 may have been stolen or used inappropriately. Based on this decision, the security code (IPAA control code) can report the current location of the stolen device 100 to a proper authority, via the Internet or the like, or via the RF-based wireless network.

Security policies are simple rules, such as “If<condition(s)>then<a trigger event as occurred is reported>”. Sample security policies for Pre-OS applications 144 and/or OS-Present applications 134 may include, for example:

Several failed log-on attempts by an unauthorized user;

Unauthorized changes attempted on selected platform policies;

Monitored services have been used by an unauthorized user—Services may be hardware and/or software oriented, such as disk drive access, applications, modem usage etc.);

Time Expires, including expiration of a renewable certificate, expiration of a designated time without communicating to a policy server or to a security token;

Regular Communication, including expiration of a designated time interval or an unauthorized connection to a communication medium; and

Unauthorized Tampering of Protected Storage.

These sample security policies are not limited thereto. There may be single factors or multiple factors for user authentication such as a single password, any unauthorized changes attempted on selected platform policies, any unauthorized use of monitored services by an unauthorized user (such as disk drive access, applications, modem usage etc.), a certain time expiration based on a renewable certificate, or lack of communication to a policy server or to a security token (such as a smart card and an USB key), or any unauthorized deletion of a protected storage. In other embodiments, there may be multiple factors of other user authentication techniques which may be included, such as, for example, a retinal scan, a fingerprint scan, a voice print identification, location of logon such as an Internet Protocol (I.P.) address, a smart card scan etc.

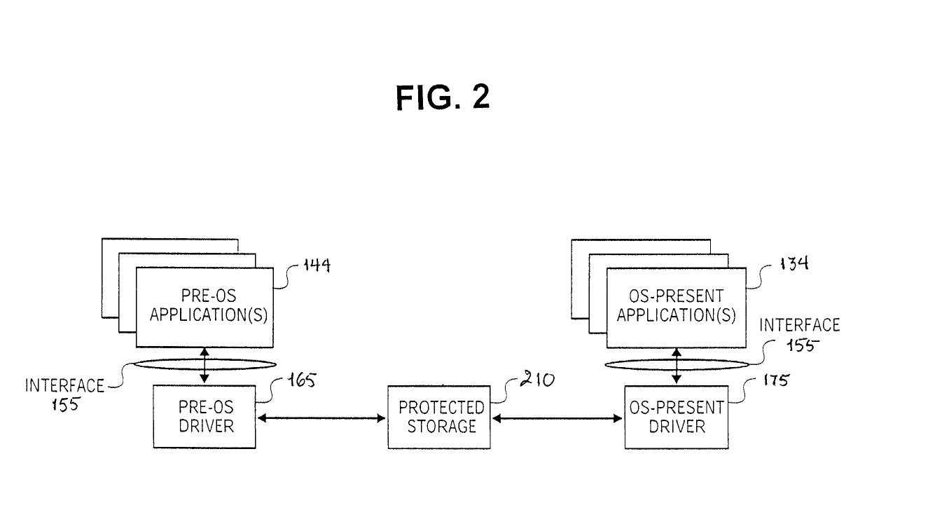

FIG. 2 illustrates an example protected storage 210 for supporting Pre-OS applications 144 and OS-Present applications 134 according to an embodiment of the present invention. As shown in FIG. 2, the protected storage 210 may be the protected storage hardware or hardware layer of the Intel® Protected Access Architecture (IPAA) described in Application Interface Specification, Revision 1.0 available from Intel Corporation of Santa Clara, Calif. (the “IPAA Specification”) to store configuration data, security policies, authentication data and other information between the Pre-OS application (system BIOS) 144 and the OS-Present application 134. Interface 145 may be the interface layer described in the IPAA Specification, Pre-OS driver 165 and OS-Present driver 175 may be the support layer or service provider described in the IPAA Specification.

Pre-OS driver 165 may provide the interface between the Pre-OS applications 144 and the protected storage 210. Likewise, the OS-Present driver 175 may provide the interface between the OS-Present applications 134 and the protected storage 210. The drivers 165 and 175 provide interfaces that enable applications to access the protected storage 210.

Protected storage 210 may be connected to the host chipset 120 and may be any nonvolatile readable and writeable memory device, such as, for example, magnetic storage media including hard disks, optical storage media including CDRW, flash memory devices, stick memory devices, and the like. In one embodiment, the protected storage 210 is permanent to the electronic device such as the mobile PC 100 and may not be easily removed.

Protected storage 210 may be used to store information about both how the identity of a user was determined and how the user was authorized so that particular applications or the operating system (OS) may make a determination if one or more additional authentication measures are required or if access should be denied by way of the security policies.

For example, a Pre-OS application (system BIOS) 144 may require that the user type in a password as authentication information. The system BIOS 144 may then store this information in the protected storage 210 regardless whether the logon attempt is successful.

If the logon attempt is successful, a later executing Pre-OS application program may access this password information or a message from the system BIOS 144 that the user was authenticated by receipt of a password. Based on receipt of this authentication information, the later executing Pre-OS application program 144 may choose not to request a typed in password. The same may apply for OS-Present application programs 134. Another Pre-OS application or an OS-Present application may obtain further authentication information from a user and either store the authentication information in the protected storage 210 or store an information specifically directed to another OS-Present application. The information passed may be the specific authentication information or may be a notice stating whether the authentication was successful. In this way, later executing Pre-OS and OS-Present applications may use earlier obtained authentication information from the protected storage 210 to either alleviate the need to further authenticate or reduce the extent of later authentication measures. For example after receiving a password, a later application may not seek a password from the user and may only request the sliding of a smart card or the presentation of a biometric means of authentication such as voice print, retinal scan, fingerprint scan and smart card scan etc.

If the several logon attempts are unsuccessful, however, the security code (IPAA control code) of the Pre-OS application program (system BIOS) 144 makes a decision that the mobile PC 100 may have been stolen or used inappropriately. The security code (IPAA control code) of the Pre-OS application (system BIOS) 144 may then access the RF-based locator subsystem 170 to determine the current location of the mobile PC 100 and report the current location of the stolen device 100 to a proper authority, via the Internet or the like, or via the RF-based wireless network.

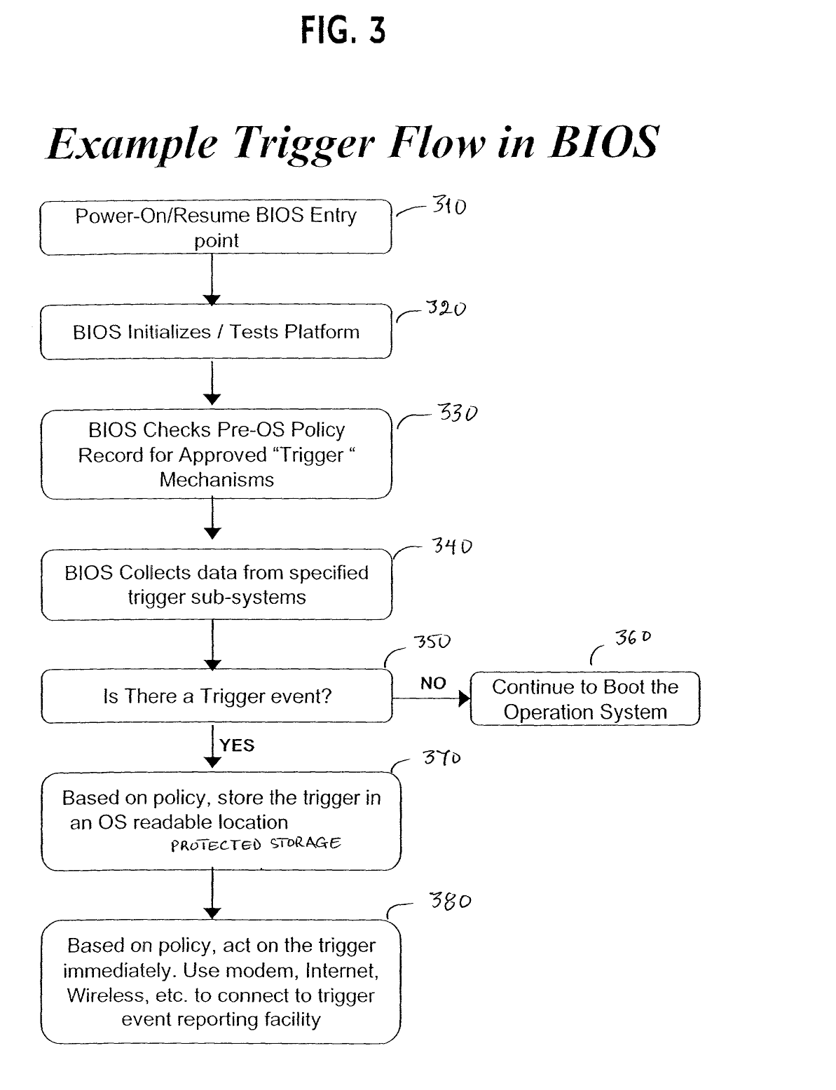

FIG. 3 illustrates an application flow of an example Pre-OS application program (system BIOS) 144 for enforcing security policies according to an embodiment of the present invention. As shown in FIG. 3, when the power is turned on (or during certain resume sequences) until control is passed to the operating system (OS) 132 at block 310, the system BIOS 144 initializes and tests the platform at block 320. The system BIOS 144 then checks the Pre-OS security policy record for approved “trigger” mechanisms, i.e., the RF-based locator subsystem 170 at block 330. The system BIOS 144 then collects data from the specified trigger sub-systems, the location based information from the RF-based locator subsystem 170 at block 340.

Next, the system BIOS 144 determines if there is a trigger event, that is, if there is a violation of the security policies during user authentication at block 350. A trigger event occurs when there are several failed logon attempts, unauthorized changes attempted on selected platform policies, unauthorized uses of monitored services by an unauthorized user (such as disk drive access, applications, modem usage etc.), time expirations based on a renewable certificate, or lack of communication to a policy server or to a security token, or unauthorized deletions of a protected storage 210 as set forth in the security policies.

If there is no trigger event, the system BIOS 144 may continue to boot the operating system (OS) 132. However, if there is a trigger event, the system BIOS 144 makes a decision that the electronic system such as the mobile PC 100 may have been stolen or used inappropriately, and may store the trigger event in an OS readable location such as the protected storage 210 based on the security policies at block 370. The system BIOS 144 may then act on the trigger event immediately, and report the current location of the stolen device 100 to a proper authority (trigger event reporting facility), via the Internet or the like (using modems), or the RF-based wireless network (using the RF-based locator subsystem 170).

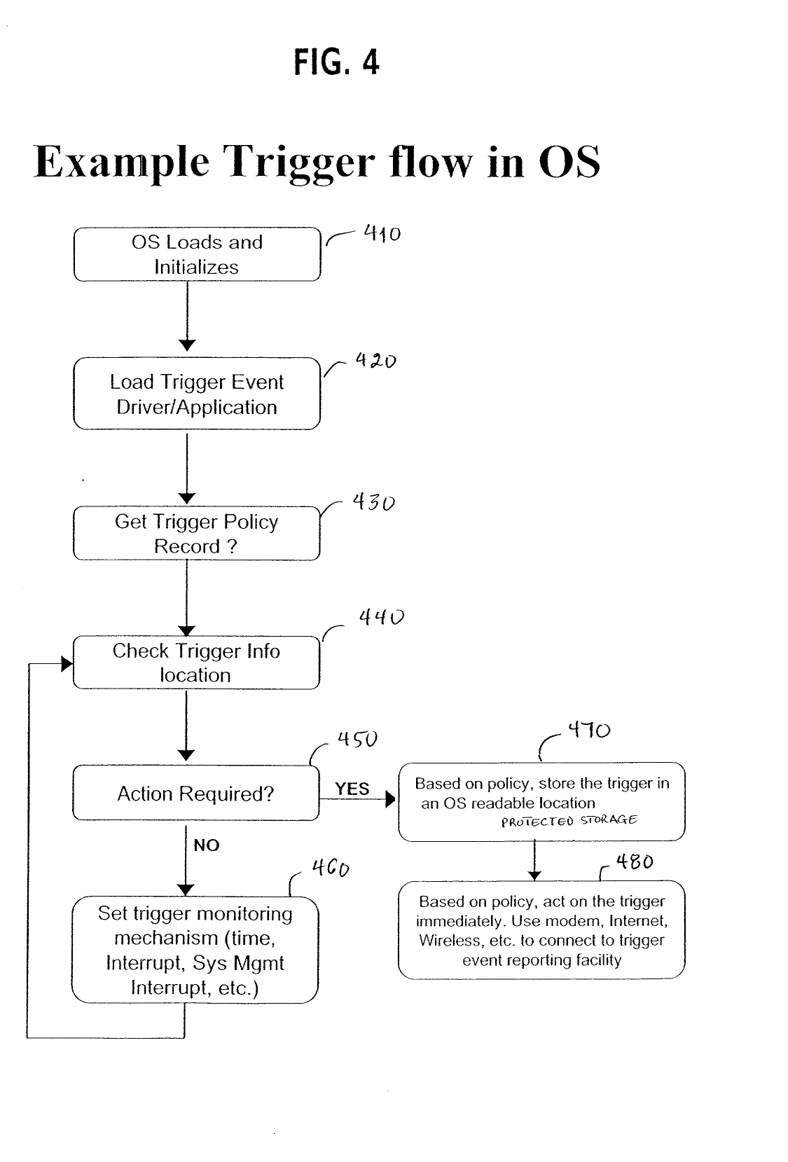

FIG. 4 illustrates an application flow of an example OS-Present application program 134 for enforcing security policies according to an embodiment of the present invention. As shown in FIG. 4, when the operating system (OS) 132 is loaded and initialized at block 410, the OS-Present application 134 may load trigger event driver/application at block 420, and obtain trigger security record for approved “trigger” mechanisms, i.e., a RF-based locator subsystem 170 at block 430. The OS-Present application 134 then checks trigger information location stored in the protected memory 210 at block 440.

Next, the OS-Present application 134 determines if an action is required based on the security policies, that is, if there is a violation of the security policies during user authentication at block 450. If no action is required, the OS-Present application 134 may set the trigger monitoring mechanism such as time, interrupt, system management interrupt etc at block 460. If an action is required, then the OS-Present application 134 makes a decision that the electronic system such as the mobile PC 100 may have been stolen or used inappropriately, and may store the trigger event in an OS readable location such as the protected storage 210 based on the security policies at block 470. The OS-Present application 134 may then act on the trigger event immediately, and report the current location of the stolen device 100 to a proper authority (trigger event reporting facility), via the Internet or the like (using modems), or the RF-based wireless network (using the RF-based locator subsystem 170) at block 480.

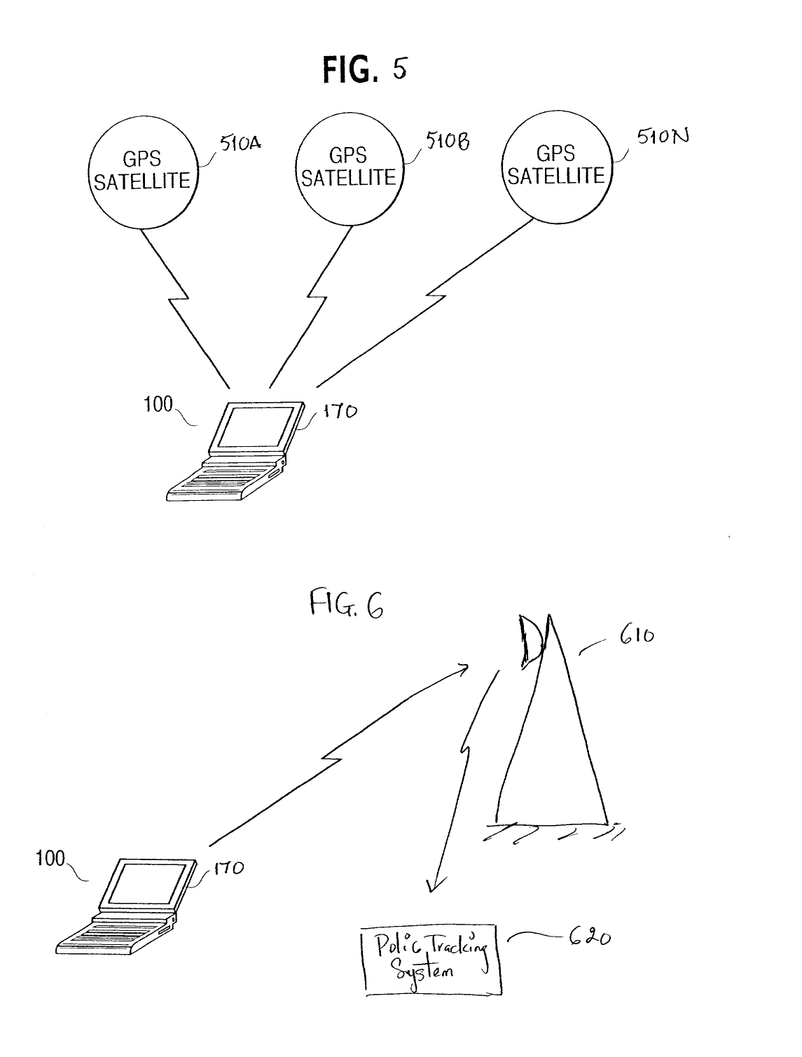

Turning now to FIGS. 5-7, various implementation examples of the RF-based locator subsystem 170 used to obtain the current location of the mobile PC 100 and, in some instances, report the location based information, via an RF-based wireless network, to a proper authority such as the police are described hereinbelow.

FIG. 5 illustrates an example RF-based locator subsystem 170 according to one embodiment of the present invention. As shown in FIG. 5, the RF-based locator subsystem 170 may be a GPS receiver that is part of an accurate three-dimensional global positioning satellite (GPS) system to obtain radio positioning and navigation information, including location based information. The RF-based locator subsystem 170 (i.e., GPS receiver) may track pseudo-random noise from a plurality of GPS satellites, via the antenna complex 172 and generate therefrom time-of-arrival values. Thereafter, the RF-based locator subsystem 170 may sample the time-of-arrival values from the GPS constellation for each of the GPS satellites 510A-510N and multiply the sample data by the speed of light to produce a plurality of pseudo-range measurements. The RF-based locator subsystem 170 then adjusts these pseudo-range measurements to compensate for deterministic errors such as the difference between each satellite's clock and GPS system time, atmospheric distortion of GPS signals and other considerations such as relativity factors. The RF-based locator subsystem 170 may include an instruction set which gathers the information necessary to compute adjustments to the pseudo-range measurements from a 50 Hz digital data stream which the GPS satellites broadcast along with their precision and coarse acquisition code. After the RF-based locator subsystem 170 makes all the necessary adjustments to the pseudo-range measurements, the position/time solution process may then be performed to determine the present GPS receiver antenna position. The RF-based locator subsystem 170 may compute its X, Y, Z position fix in terms of the World Geodetic System adapted in 1984, which is the basis on which the GPS develops its worldwide common grid references. Generally, the X, Y, Z coordinates are converted to latitude, longitude and altitude map datum prior to output. The GPS position solution is intrinsically referenced to the electrical phase center of the antenna. Finally, the RF-based locator subsystem 170 may compute clock bias results which are one of the parameters to be considered in addition to the X, Y, Z coordinates. The clock bias may be computed in terms of the time offset of the clock in the RF-based locator subsystem 170 versus GPS system time. Accordingly, the location based information is obtained to establish the current location of the mobile PC 100.

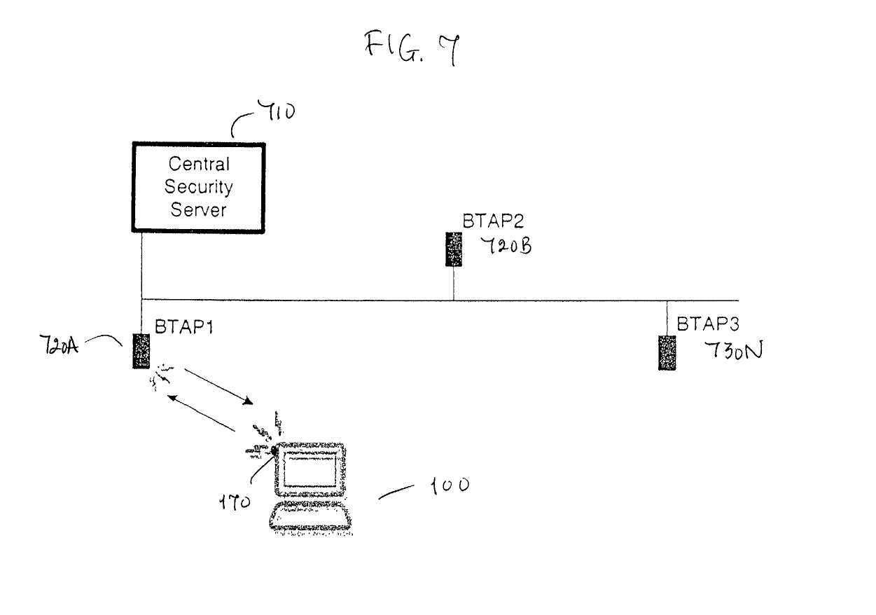

FIG. 6 illustrates an example RF-based locator subsystem 170 according to another embodiment of the present invention. As shown in FIG. 6, the RF-based locator subsystem 170 may be a RF transmitter that is part of a stolen device recovery system to provide location based information. The RF-based locator subsystem 170 (i.e., RF transmitter) may be activated upon an occurrence of a trigger event to broadcast a silent, coded radio signal to a police tracking system 620, via a police radio tower 610. The police tracking system 620 may then identify the stolen device 100 and allow the police to track the stolen device.

FIG. 7 illustrates an example RF-based locator subsystem 170 according to yet another embodiment of the present invention. As shown in FIG. 7, the RF-based locator subsystem 170 may be a Bluetooth™ transceiver that is part of a Bluetooth™ based security system including a central security server 710 and a network of Bluetooth (voice/data) Access Points (BTAPs) 720A-720N installed in a designated area such as a company site, a school, a building or an industry complex to provide security services for the mobile PC 100, including asset control, remote monitoring and tracking of the mobile PC 100, through the Internet or other networks whenever possible. Such a Bluetooth™ transceiver can determine information relating to the current location of the mobile PC 100 relative to the BTAPs 720A-720N by communicating with several BTAPs 720A-720N. The RF-based locator subsystem 170 (i.e., Bluetooth™ transceiver) may be activated upon an occurrence of a trigger event to report the current location of the mobile PC 100 to a proper authority, via the central security server 710.

As described in this invention, the radio location based theft recovery mechanism can provide access control, tracking and security services of varying complexity. Pre-OS applications and OS-Present applications may be deployed to mobile PCs manually or via networks. Such software programs may be a software module provided on a tangible medium, such as a floppy disk or compact disk (CD) ROM, or via Internet downloads, which may be available for an IT administrator to conveniently plug-in or download into the host operating system (OS). Such software modules may also be available as a firmware module or a comprehensive hardware/software module which may be built-in the host. In addition, method steps of FIGS. 3-4 may be performed by a computer processor executing instructions organized into a program module or a custom designed state machine. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; and optical media such as CD-ROM disks.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, IEEE 802.11b standards systems may be utilized as a wireless local area network (LAN) in lieu of the Bluetooth based system in order to specify an “over the air” interface between a wireless client and a base station or access point (AP), as well as among wireless clients. Transceivers may use the IEEE 802.11b standard to communicate with transmitters using the IEEE 802.11b standard and with each other to determine position relative to the transmitters. Many modifications may be made to adapt the teachings of the present invention to a particular situation without departing from the scope thereof. Therefore, it is intended that the present invention not be limited to the various exemplary embodiments disclosed, but that the present invention includes all embodiments falling within the scope of the appended claims.

What is claimed is:

1. A mobile system, comprising:
a host chipset;
a locator subsystem connected to the host chipset and arranged to determine a current location of the mobile system; and
a main storage connected to the host chipset and arranged to store an operating system (OS) and contain an OS-Present application and/or a Pre-OS application configured to enforce security policies during user authentication, to access the locator subsystem and determine whether the mobile system may have been stolen or used inappropriately based on the security policies.

2. The mobile system as claimed in claim 1, wherein said main storage comprises:
a main memory arranged to store the operating system (OS), and the OS-Present application which is executed while the operating system (OS) is present; and
a flash memory arranged to store the Pre-OS application which is executed during boot up before the operating system (OS) is loaded.

3. The mobile system as claimed in claim 2, further comprising:
a protected storage configured to support the Pre-OS application and the OS-Present application and to store configuration data, the security policies, authentication data and other information obtained from the Pre-OS application and the OS-Present application.

4. The mobile system as claimed in claim 3, further comprising:
a first interface arranged to provide the Pre-OS application access to the protected storage; and
a second interface arranged to provide the OS-Present application access to the protected storage.

5. The mobile system as claimed in claim 3, wherein said protected storage is a nonvolatile readable and writeable memory device.

6. The mobile system as claimed in claim 3, wherein said locator subsystem corresponds to a radio-frequency (RF) based locator subsystem for determining the current location of the mobile system.

7. The mobile system as claimed in claim 6, wherein said security policies for the Pre-OS application and the OS-Present application include a designated number of failed log-on attempts, an unauthorized change attempted on selected platform policies, an unauthorized use of monitored services, a designated time expiration based on a renewable certificate, or a lack of communication to a policy server or to a security token, and an unauthorized deletion of the protected storage.

8. The mobile system as claimed in claim 7, wherein said Pre-OS application corresponds to a system basic input/output start-up (BIOS) that is configured in accordance with Intel® Protected Access Architecture (IPAA) described in Application Interface Specification, Revision 1.0, and that is executed during boot up before the operating system (OS) is loaded.

9. The mobile system as claimed in claim 8, wherein said system BIOS is executed during boot up to check a Pre-OS security policy record, collect location based information from the RF-based locator subsystem, determine if there is a violation of the security policies during user authentication and, if there is a violation of the security policies, make a decision that the mobile system may have been stolen or used inappropriately.

10. The mobile system as claimed in claim 9, wherein said system BIOS is executed during boot up to further report the location of the mobile system to a proper authority, via an Internet or a RF-based wireless network.

11. The mobile system as claimed in claim 7, wherein said OS-Present application is executed to obtain an OS security record, check location based information, determine if an action is required based on the security policies and, if an action is required, then report a violation to an OS readable location in the protected storage and/or an external event monitoring facility.

12. The mobile system as claimed in claim 11, wherein said RF-based locator subsystem corresponds to a Global Positioning System (GPS) receiver connected to the host chipset and arranged to contain an antenna complex for receiving the current location of the mobile system.

13. The mobile system as claimed in claim 11, wherein said RF-based locator subsystem corresponds to a RF transmitter that is part of a stolen device recovery system to provide location based information and is activated upon an occurrence of a trigger event to broadcast a silent, coded radio signal to the stolen device recovery system, via a radio tower, for enabling the police to track and recover the stolen device.

14. The mobile system as claimed in claim 11, wherein said RF-based locator subsystem corresponds to a Bluetooth™ transceiver that is part of a Bluetooth™ based security system including a central security server and a network of Bluetooth (voice/data) Access Points (BTAPs) installed in a designated area to provide security services for the mobile system, including asset control, remote monitoring and tracking of the mobile system, through the Internet or the RF-based wireless network.

15. A mobile system comprising:
a host chipset;
a RF-based locator subsystem connected to the host chipset and arranged to determine a current location of the mobile system;
a main memory connected to the host chipset and arranged to store an operating system (OS) and an OS-Present application executed while the operating system (OS) is present; and
a flash memory connected to the host chipset and arranged to store a Pre-OS application executed during boot up before the operating system (OS) is loaded and configured to enforce security policies during user authentication, to access the RF-based locator subsystem and determine whether the mobile system may have been stolen or used inappropriately based on the security policies.

16. The mobile system as claimed in claim 15, wherein said security policies include a designated number of failed log-on attempts, an unauthorized change attempted on selected platform policies, an unauthorized use of monitored services, a designated time expiration based on a renewable certificate, or a lack of communication to a policy server or to a security token, and an unauthorized deletion of the protected storage.

17. The mobile system as claimed in claim 16, wherein said Pre-OS application corresponds to a system basic input/output start-up (BIOS) that is configured in accordance with Intel® Protected Access Architecture (IPAA) described in Application Interface Specification, Revision 1.0, and that is executed during boot up before the operating system (OS) is loaded.

18. The mobile system as claimed in claim 17, wherein said system BIOS is executed during boot up to check a Pre-OS security policy record, collect location based information from the RF-based locator subsystem, determine if there is a violation of the security policies during user authentication and, if there is a violation of the security policies, make a decision that the mobile system may have been stolen or used inappropriately.

19. The mobile system as claimed in claim 18, wherein said system BIOS is executed during boot up to further report the current location of the mobile system to a proper authority, via an Internet or a RF-based wireless network.

20. The mobile system as claimed in claim 15, wherein said OS-Present application is executed to obtain an OS security record, check location based information, determine if an action is required based on the security policies and, if an action is required, then report a violation to an OS readable location in the protected storage and/or an external event monitoring facility.

21. The mobile system as claimed in claim 15, wherein said RF-based locator subsystem corresponds to a Global Positioning System (GPS) receiver connected to the host chipset and arranged to contain an antenna complex for receiving the current location of the mobile system.

22. The mobile system as claimed in claim 15, wherein said RF-based locator subsystem corresponds to a RF transmitter that is part of a stolen device recovery system to provide location based information and is activated upon an occurrence of a trigger event to broadcast a silent, coded radio signal to the stolen device recovery system, via a radio tower, for enabling the police to track and recover the stolen device.

23. The mobile system as claimed in claim 15, wherein said RF-based locator subsystem corresponds to a Bluetooth™ transceiver that is part of a Bluetooth™ based security system including a central security server and a network of Bluetooth (voice/data) Access Points (BTAPs) installed in a designated area to provide security services for the mobile system, including asset control, remote monitoring and tracking of the mobile system, through the Internet or the RF-based wireless network.

24. A computer readable medium having stored thereon a set of system basic input/output start-up “system BIOS” instructions configured in accordance with Intel® Protected Access Architecture (IPAA) which, when executed by a processor during start-up, cause the processor to perform:
initializing and testing a system platform;
checking a Pre-OS security policy record for an approved trigger mechanism;
collecting location based information from the approved trigger mechanism;
determining if there is a violation of security policies during user authentication; and
if there is a violation of the security policies, making a decision that the mobile system may have been stolen or used inappropriately.

25. The computer readable medium as claimed in claim 24, wherein said system BIOS instructions further cause the processor to report the location based information indicating the current location of the mobile system to a proper authority, via an Internet or a RF-based wireless network, when there is a violation of the security policies.

26. The computer readable medium as claimed in claim 24, wherein said security policies for the system BIOS instructions include a designated number of failed log-on attempts, an unauthorized change attempted on selected platform policies, an unauthorized use of monitored services, a designated time expiration based on a renewable certificate, or lack of communication to a policy server or to a security token, and an unauthorized deletion of a protected storage.
